(19) United States
(12) Patent Application Publication
(10) Pub. No.: US 2007/0253342 A1
(43) Pub. Date: Nov. 1, 2007

(54) System for automatically configuring a communication interface module

(75) Inventors: Paul W. Bierdeman, East Peoria, IL (US); Steven Wayne O'Neal, Bartonville, IL (US); Jeffrey Michael Lamb, La Grange, IL (US); Trent Ray Meiss, Eureka, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/413,188

(22) Filed: Apr. 28, 2006

(51) Int. Cl. H04L 12/28

(52) U.S. Cl. 370/254

(57) ABSTRACT

A system for automatically configuring a communication interface module is disclosed. The communication interface module may include a plurality of data link ports and auto-configuration logic. The auto-configuration logic may be configured to determine a data link type for a data link connected to at least one of the plurality of data link ports and determine whether a local configuration file corresponding to the data link type is available. The auto-configuration logic may be configured to acquire a remote configuration file for the data link from an external source if a local configuration file is not available. The auto-configuration logic may configure the communication interface module, using the local configuration file or the remote configuration file, to communicate over the data link.

### TECHNICAL FIELD

The present disclosure relates generally to a communication interface module, and more particularly, to a system and method for auto-configuring a communication interface module.

### BACKGROUND

Communication interface modules or devices, for example gateway devices, may typically require manual configuration when installed on a machine. Manual configuration may be required to determine the types of data links that may be connected to the communication interface module when it is installed. Manual configuration may also be required to make configuration settings to the hardware or software of the communications interface module that correspond to the data link types and/or to devices attached to the data links. Such manual configuration may require time or manpower because a technician may be sent to the field or other location of the machine for installation and configuration of the communication interface module. Further, a need for manual configuration may limit the frequency with which a communication interface module configuration may be updated.

One method of automatically configuring a device communicating on a bus is described in U.S. Patent Application Publication No. 2004/0073912 (the '912 publication). The '912 publication is directed to a system and method for automatically detecting the attachment of a peripheral device to a host system, and configuring the host system for communications with the peripheral device. If a device driver for the peripheral is locally available, then the host system installs and loads the device driver. If the device driver is not locally present, then the host system establishes a connection with a server system that includes a database with the device driver needed for operation of the device. The host may then retrieve the device driver from the server, install the device driver, and load the device driver.

Although the '912 publication may address an automatic configuration of a host system with a peripheral device driver, it may be insufficient to address the problem of auto configuration of a communications interface module. For example, the system and method of the '912 publication may be used to configure a host with a device driver needed to communicate with an attached peripheral device. However, the system and method may not be applicable for use in a communication interface module that may not be a host system. Also, the system and method of the '912 publication may identify a peripheral device that is attached to a bus, but may not be applicable to identification of a data link type. Further, the system and method of the '912 publication may not be applicable to configuring a device that may be a peripheral device of another system and the method may be limited to initial installation of a peripheral device driver.

The disclosed system and method are directed to overcoming one or more of the problems set forth above.

### SUMMARY OF THE INVENTION

In one aspect, the present disclosure is directed to a system for automatically configuring a communication interface module. The communication interface module may include a plurality of data link ports and auto-configuration logic. The auto-configuration logic may be configured to determine a data link type for a data link connected to at least one of the plurality of data link ports and determine whether a local configuration file corresponding to the data link type is available. The auto-configuration logic may also be configured to acquire a remote configuration file for the data link from an external source if a local configuration file is not available. The auto-configuration logic may also configure the communication interface module to communicate over the data link based on the local configuration file or the remote configuration file.

In another aspect, the present disclosure is directed to a method for automatically configuring a communication interface module. The method may include determining a data link type for a data link connected to the communication interface module. Once a data link type has been determined, the method may include determining whether a local configuration file corresponding to the data link type is available. If a local configuration file is a not available, the method may include acquiring a remote configuration file for the data link from an external source. The method may include configuring the communication interface module to communicate over the data link using the local configuration file or the remote configuration file.

In another aspect, the present disclosure is directed to a machine including a communication interface module. The communication interface module may include a plurality of data link ports and a processor. The processor may be configured to determine a data link type for a data link connected to at least one of the plurality of data link ports. The processor may be configured to determine whether a local configuration file corresponding to the data link type is available. The processor may be configured to acquire a remote configuration file for the data link from an external source if the local configuration file is not available. The processor may be configured to configure the communication interface module, using the local configuration file or the remote configuration file, to communicate over the data link.

### BRIEF DESCRIPTION OF THE DRAWINGS

FIG. 1 is a block diagram representation of an exemplary machine communication system;

FIG. 2 is a block diagram representation of an exemplary disclosed communication interface module; and

FIG. 3 is a flowchart illustrating an exemplary disclosed method of automatically configuring a communication interface module.

### DETAILED DESCRIPTION

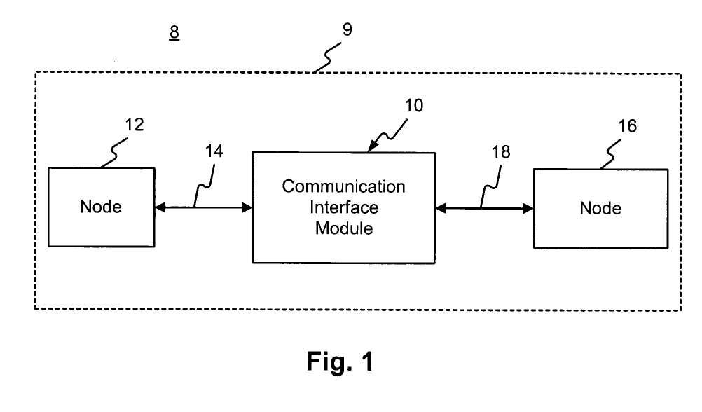

FIG. 1 illustrates an exemplary machine communication system 8 including machine 9, communication interface module 10, node 12, data link 14, node 16, and data link 18. Communication interface module 10 may be coupled to node 12 via data link 14. Communication interface module 10 may also be coupled to node 16 via data link 18. Node 12 and node 16 may include other processors, communications interfaces, control modules, or data ports disposed onboard or offboard machine 9. For example, node 12 may include a remote configuration server or offboard processor, and node 16 may include an onboard processor or electronic module. It should be appreciated that two nodes are shown for purposes of illustration and that more than two nodes may be used with the communication module of the present disclosure. The terms “remote configuration server” and “offboard processor,” for purposes of the present disclosure, refer to a system, server, or the like that is disposed offboard of a machine where the communication module is disposed. The term “onboard processor,” for purposes of the present disclosure, refers to a module, system, server, or the like that is disposed onboard the machine on which the communication module is disposed. It should be appreciated that communication interface module 10 may be disposed on machine 9, which may include, for example, an earth moving machine such as an excavator, a dozer, a loader, a backhoe, a motor grader, a dump truck, other earth moving machine, marine vessel, or other vehicle. Communication interface module 10 may be used on any machine where a communication interface module with auto configuration may be desirable.

Data link 14 and data link 18 may be of the same or different data link type. Data link 14 and data link 18 may include any data link type such as, for example, RS-232, RS-485, Ethernet, IEEE 802.11b, a proprietary data link, a non-proprietary data link, optical, or other known, or later developed, wired or wireless data link type, machine-specific, vessel-specific, or vehicle-specific data link type, such as, for example, a National Marine Electronics Association (NMEA) marine vessel bus, a Controller Area Network (CAN) bus, or the like. It should be appreciated that a data link type may depend upon a contemplated use of a data link or a type of machine on which the data link may be used.

Communication interface module 10 may operate to provide a connection between data link 14 and data link 18, so that node 12 and node 16 may communicate. Communication interface module 10 may provide protocol translation support for bridging communications between data links of differing types. Communication interface module 10 may also provide parameter or data translation for data messages passing through data links connected to communication interface module 10. Communication interface module 10 may operate as a peer, or as a peripheral of node 12 and/or node 16.

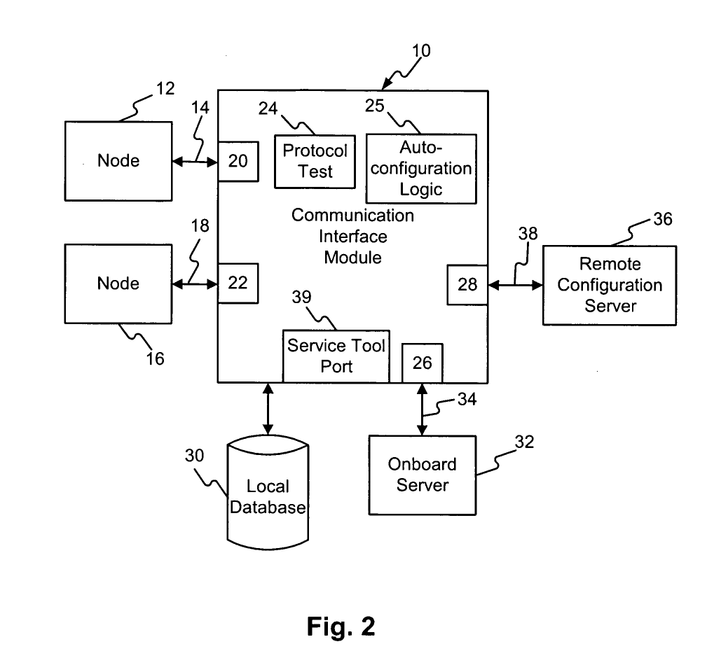

FIG. 2 shows a block diagram representation of exemplary disclosed communication interface module 10. In particular, communication interface module 10 may include first data link port 20, second data link port 22, protocol test module 24, auto-configuration logic 25, onboard data bus port 26, remote data bus port 28, and service tool port 39. Communication interface module 10 may be connected to a local database 30. Communication interface module may also be connected to an onboard server 32 via an onboard data bus 34 and/or remote configuration server 36 via a remote data link 38.

When communication interface module 10 is installed on a machine or powered up, for example, it may automatically determine a data link type for data link 14 and data link 18 using auto-configuration logic 25. Automatic determination of data link type by auto-configuration logic 25 may be based on an electrical characteristic, physical characteristic, data content of a data link signal, or a combination of the above. For example, auto-configuration logic 25 may route data received from data link 14 at data link port 20, and data link 18 at data port 22, to protocol test module 24 for protocol analysis. During protocol analysis, data received from data link 14 and data link 18 may be evaluated against known protocols in order to determine a protocol being used on each data link and a data link type corresponding to the protocol. A data link type, for each data link where a protocol determination is possible, may be provided by protocol test module 24 to auto-configuration logic 25.

In cases where protocol determination may not be possible or applicable using protocol test module 24, auto-configuration logic 25 may receive data link type information from onboard server 32, which may be an onboard processor or server, via onboard bus 34 and onboard data port 26. Onboard server 32 may have data link type information stored and may transmit the data link type information to communication interface module 10 automatically or upon request by auto-configuration logic 25. Alternatively, auto-configuration logic 25 may receive data link type information from remote configuration server 36, which may be an offboard processor or server, via remote data link 38 and remote data link port 28. For example, upon installation or power up, auto-configuration logic 25 may contact remote configuration server 36 and request data link type information. Remote configuration server 36 may also send data link type information automatically. Such data link type information may include machine, vessel or vehicle configuration information that may be used by auto-configuration logic 25 to determine data link type. It should be appreciated that the onboard data bus and remote data link may include wired or wireless connections.

Once a data link type has been determined, for data link 14 and/or data link 18, for example, a configuration file may be identified that corresponds to the data link type. Also, one or more data link type determinations may be used to identify a configuration file suitable for configuring some or all of the data link ports attached to communication interface module 10. The configuration file may be used to configure one or more of the data link ports of communication interface module 10 so that communications according to a protocol associated with the data link type are possible. For example, a configuration file may include a configuration for one specific data link type, or may include a configuration for all of the data links connected to communication interface module 10. In other words, there may be pre-defined standard configurations for communication interface module 10. A configuration file may be created to supply some or all of the configuration information needed for these standard configurations.

For example, communication interface module 10 may be used on a machine having a fixed, known set of data link types and devices connected to those data links. A configuration file may exist that may be designed to configure communication interface module 10 according to the known data link types and connected devices for the machine. Communication interface module 10 may detect a set of data links corresponding to a known machine configuration and request a corresponding configuration file to configure all of the data link ports.

Communication interface module 10 may have configuration files stored internally. These internal configuration files may have been pre-loaded when the module was manufactured, or may have been loaded through service tool port 39 by a technician, other person, or system. Configuration files may be stored within communication interface module 10 in random access memory (RAM), battery-backed RAM, read-only memory (ROM), flash memory, electrically erasable programmable read-only memory (EEPROM), or other suitable data storage medium or device. Auto-configuration logic 25 may retrieve a configuration file from internal configuration files stored in communication interface module 10.

Auto-configuration logic 25 may also retrieve a local configuration file from local database 30. Local database 30 may include a database internal to communication interface module 10 or may include a database onboard a machine where communication interface module 10 is disposed.

Alternatively, if an internal or local configuration file is not available, then auto-configuration logic 25 may request a remote configuration file from remote configuration server 36. While communication interface module 10, may, in some embodiments, be configured automatically, in other embodiments, the configuration may be supplemented manually. For example, manual configuration may include setting a path or route for the communication interface module 10 to access remote configuration server 36. A default path, or server address mapping, may be pre-loaded into communication interface module 10. The default path may not be applicable to a particular machine or installation, thus a different remote configuration server path may be required in order for communication interface module 10 to access remote configuration server 36.

Communication interface module 10 may also request a configuration file from onboard server 32. For example, onboard server 32 may include an onboard server used to provide configuration files, or other files, when a connection to remote configuration server 36 may not be possible or practical, such as, for example, when a marine vessel is at sea.

Using the local configuration file and/or the remote configuration file, auto-configuration logic 25 may configure the data link ports of communication interface module 10. Once configured, communication interface module 10 may be operable on connected data links, including data link 14 and data link 18, for example.

It should be appreciated that communication interface module 10, protocol test module 24, and auto-configuration logic 25 may each include hardware, software, or a combination of the above. Communication interface module 10, protocol test module 24, and auto-configuration logic 25 may each be a separate module, or two or more of the above may be combined. Auto configuration logic 25 may include a processor disposed in communication interface module 10.

### INDUSTRIAL APPLICABILITY

The disclosed system and method for automatically configuring a communication interface module may be applicable to any communication interface module for which automatic configuration may be desired. The disclosed system and method for automatically configuring a communication interface module may be used in communication interface modules for machines, such as vessels, vehicles, or the like.

Several advantages over the prior art may be associated with the disclosed system and method for automatically configuring a communication interface module. For example, the disclosed system and method may be used to configure a non-host communication interface module. A host system may be a central system that generates, receives, and/or processes communications from peripheral devices or other processors. In contrast, a non-host system or communication module may include, for example, an interface module for interconnecting other processors or devices.

In another example, the disclosed system and method may identify a type of bus, or data link, that is attached to the communication interface module. Further, the disclosed system and method may automatically configure a communication interface module using information received from an onboard system to determine a data link type of data links connected to the communication interface module.

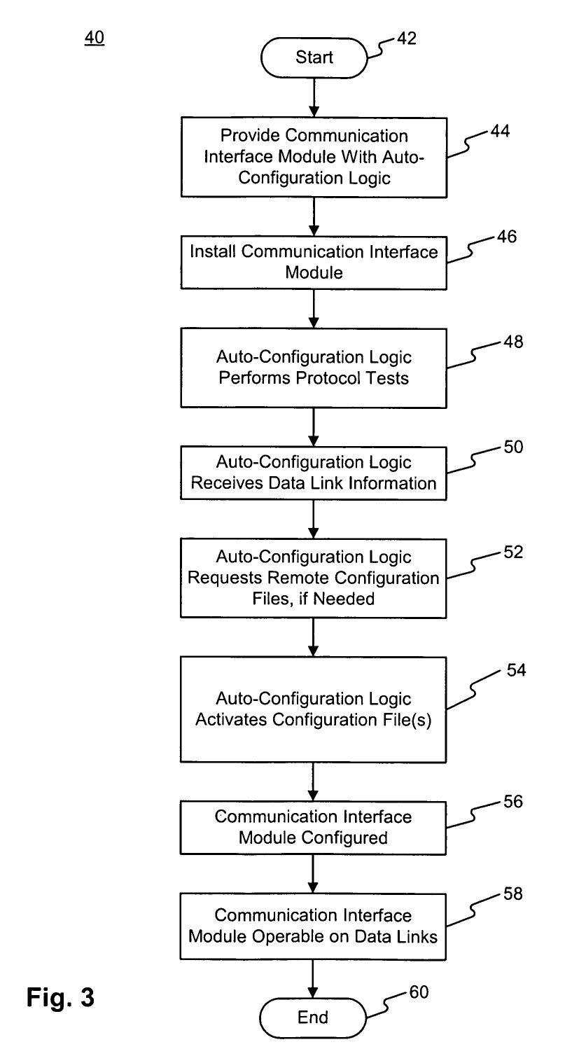

FIG. 3 is a flowchart 40 illustrating an exemplary method of automatically configuring a communication interface module. In particular, the first step after start (step 42) of the method may include providing a communication module including auto-configuration logic comprising software and/or hardware (step 44). Next, the communication module may be installed on a machine (step 46). Installing the communication interface module may include connecting one or more data links to the communication interface module.

Once installed, the auto-configuration logic may perform a built-in protocol test to identify a data link type for each data link connected to the communication interface module (step 48). Optionally, the auto-configuration software may receive data link type information from an onboard system or from an external system (step 50). The onboard system or external system may provide the data link type information automatically or in response to a request from the communication interface module.

Once data link types have been determined for each connected data link, the auto-configuration logic attempts to locate a local configuration file corresponding to each identified data link connected to the communication interface module. The auto-configuration logic may request a remote data configuration file for any data link type for which an internal or local configuration file may not be available (step 52). The remote configuration file may be received from an onboard system, an external configuration server, or other processor or system. For example, the auto-configuration logic may pull required configuration files over an Ethernet connection using TCP/IP from the remote server each time the machine starts up. The local configuration file or remote configuration file for each data link type is activated (step 54).

Based on an activated local configuration file or remote configuration file, each data link may be configured to communicate according to a corresponding data link type (step 56). Once configured, the communication interface module may be operable to communicate on connected and configured data links (step 58). Once the auto-configuration logic has automatically configured the communication interface module to communicate on connected data links, the method ends (step 60). The method may be repeated as necessary for updating or reinstalling the communication interface module, or when a configuration change may warrant an update to the configuration of the communication interface module. Configuration files may be loaded and activated at initial installation, start-up, shut-down, during operation, or a combination of the above as may be desired to maintain a current configuration.

It will be apparent to those skilled in the art that various modifications and variations can be made to the methods and systems of the present disclosure. Other embodiments of the methods and systems will be apparent to those skilled in the art from consideration of the specification and practice of the methods and systems disclosed herein. It is intended that the specification and examples be considered as exemplary only, with a true scope of the disclosure being indicated by the following claims and their equivalents.

What is claimed is:

1. A communication interface module comprising:
a plurality of data link ports; and
auto-configuration logic configured to:
determine a data link type for a data link connected to at least one of the plurality of data link ports;
determine whether a local configuration file corresponding to the data link type is available;
acquire a remote configuration file for the data link from an external source if the local configuration file is not available; and
configure the communication interface module, using the local configuration file or the remote configuration file, to communicate over the data link.

2. The communication interface module of claim 1, further including a protocol test module to perform a protocol test in order to determine a data link type.

3. The communication interface module of claim 1, wherein the auto-configuration logic is further configured to receive data link configuration information from an onboard system in order to determine the data link type.

4. The communication interface module of claim 1, wherein the auto-configuration logic is further configured to use a protocol associated with the data link type in the local configuration file or the remote configuration file to communicate on the data link.

5. The communication interface module of claim 1, wherein the auto-configuration logic is further configured to associate the data link type, including a communication protocol based on the local configuration file or the remote configuration file, with a corresponding data link port.

6. The communication interface module of claim 1, wherein the external source includes one of an onboard processor or an offboard processor.

7. A method for automatically configuring a communication interface module on a machine, the method comprising:
determining a data link type for a data link connected to the communication interface module;
determining whether a local configuration file corresponding to the data link type is available;
acquiring a remote configuration file for the data link from an external source if the local configuration file is not available; and
configuring the communication interface module using the local configuration file or the remote configuration file, to communicate over the data link.

8. The method of claim 7, wherein determining a data link type for the data link includes performing a built-in protocol test.

9. The method of claim 7, wherein determining a data link type for the data link includes receiving data link configuration information from an onboard processor.

10. The method of claim 7, wherein determining a data link type for the data link includes receiving data link information from an offboard processor.

11. The method of claim 7, wherein the external source includes an onboard processor.

12. The method of claim 7, wherein the external source includes an offboard processor.

13. The method of claim 7, wherein configuring the communication interface module includes configuring a communication port for communications on the data link using a protocol identified by the local configuration file or the remote configuration file.

14. The method of claim 7, wherein configuring the communication interface module includes associating the data link type, including a communication protocol based on the local configuration file or the remote configuration file, with a corresponding data link port.

15. A machine comprising:
a communication interface module including:
a plurality of data link ports; and
a processor configured to:
determine a data link type for a data link connected to at least one of the plurality of data link ports;
determine whether a local configuration file corresponding to the data link type is available;
acquire a remote configuration file for the data link from an external source if the local configuration file is not available; and
configure the communication interface module, using the local configuration file or the remote configuration file, to communicate over the data link.

16. The machine of claim 15, wherein the processor is further configured to perform a built-in protocol test in order to determine the data link type.

17. The machine of claim 15, wherein the processor is further configured to receive data link configuration information from an onboard system in order to determine the data link type.

18. The machine of claim 15, wherein the processor is further configured to receive data link configuration information from an offboard system in order to determine the data link type.

19. The machine of claim 15, wherein the processor is further configured to use a protocol associated with the data link type in the local configuration file or the remote configuration file to communicate on the data link.

20. The machine of claim 15, wherein the processor is further configured to associate the data link type, including a communication protocol based on the local configuration file or the remote configuration file, with a corresponding data link port.
